(19) United States
(12) Patent Application Publication
(10) Pub. No.: US 2014/0009540 A1
(43) Pub. Date: Jan. 9, 2014

(54) RECORDING APPARATUS

(71) Applicant: SEIKO EPSON CORPORATION, Tokyo (JP)

(72) Inventors: Kazutoshi MATSUZAKI, Shiojiri-shi (JP); Kazumasa HARADA, Matsumoto-shi (JP); Keiji HARA, Shiojiri-shi (JP); Tadahiro MIZUTANI, Shiojiri-shi (JP); Izumi NOZAWA, Matsumoto-shi (JP); Hidetoshi KODAMA, Matsumoto-shi (JP); Isamu TOGASHI, Matsumoto-shi (JP)

(21) Appl. No.: 13/935,889

(22) Filed: Jul. 5, 2013

(30) Foreign Application Priority Data
Jul. 6, 2012 (JP) 2012-152147
Aug. 7, 2012 (JP) 2012-175199

(51) Int. Cl. B41J 2/175

(52) U.S. Cl. CPC B41J 2/1752
USPC 347/86

(57) ABSTRACT

An ink cartridge is formed with a cartridge-side engaging portion having a form inherent among a plurality of ink cartridges, and a cartridge mounting chamber in which the ink cartridges are mounted is formed with cartridge-mounting-chamber-side engaging portions, and these engaging portions constitute an erroneous mounting preventing structure.

### BACKGROUND

1. Technical Field

The present invention relates to a recording apparatus represented by a facsimile or a printer.

2. Related Art

In the related art, there is an ink jet printer provided with a cartridge mounting chamber configured to house a plurality of ink cartridges containing different colors of ink or ink cartridges containing different types of ink such as dye-based and pigment-based ink even though the color is the same individually. In such an ink jet printer, there is a risk of erroneous mounting of an ink cartridge on a position different from a proper position where the ink cartridge in question is to be mounted especially when replacing two or more ink cartridges simultaneously.

In order to accommodate such a problem, in an ink jet printer described in JP-A-2003-54007, ink cartridges are respectively formed with engagement guiding portions having different forms depending on the ink colors in the individual ink cartridges, and on the other hand, on the side of the carriages (the ink cartridge mounting chamber side), engagement receiving portions configured to engage the engagement guiding portions are formed at positions corresponding to the engagement guiding portions. In other words, the engagement guiding portions and the engagement receiving portions are in one-to-one correspondence, and a so-called correspondence relationship between a key and a keyhole is established between the ink cartridges and the mounting places where the ink cartridges are mounted.

Accordingly, even though an attempt is made to mount an ink cartridge on a position different from a proper position where the ink cartridge in question to be mounted where an ink cartridge for a different color is to be mounted, mounting is not achieved because the engagement guiding portion and the engagement receiving portion do not match. In the ink jet printer described in JP-A-2003-54007, an erroneous mounting preventing structure for ink cartridges is established in the manner described above.

There are various forms of connection between an ink feeding portion on the ink cartridge side and an ink receiving port to be connected to the ink feeding portion on the ink cartridge mounting chamber side. For example, the ink jet printer disclosed in JP-A-2003-54007 has a configuration in which an ink supply needle on the ink cartridge mounting chamber side sticks and digs into an ink feeding portion (ink supply portion) on the ink cartridge side by mounting the ink cartridge.

Here, according to the erroneous mounting preventing structure for ink cartridges described above, mounting of an ink cartridge on a position different from a proper position where the ink cartridge in question is to be mounted is prevented, or more specifically, the ink cartridge is prevented from being brought into a completely mounted state in a wrong position. However, this erroneous mounting preventing structure does not function unless the ink cartridge is inserted into the ink cartridge mounting chamber (in the carriage) to some extent. Therefore, the ink receiving port on the ink cartridge mounting chamber side comes into contact with the ink feeding portion on the ink cartridge side before the erroneous mounting preventing structure functions, and consequently, there is a risk of color mixture.

### SUMMARY

An advantage of some aspects of the invention is that a recording apparatus devised to fulfill an erroneous mounting preventing function before contact of an ink feeding portion on the ink cartridge side with an ink receiving port on the ink cartridge mounting chamber side.

According to a first aspect of the invention, there is provided a recording apparatus including: a recording head configured to perform recording; and an ink cartridge mounting chamber in which a plurality of ink cartridges each having an ink feeding port configured to feed ink are mounted, wherein the ink cartridge mounting chamber includes: a side surface provided with a pivot point to allow the ink cartridges to be mounted by being pivoted, ink receiving ports connected to the ink feeding ports and provided so as to correspond to the plurality of the ink cartridges, cartridge-mounting-chamber-side engaging portions configured to be fitted in cartridge-side engaging portions provided on the ink cartridges and each having a form inherent among the plurality of the ink cartridges; and a restricting unit configured to start fitting between the cartridge-side engaging portion and the cartridge-mounting-chamber-side engaging portion prior to contact between the ink feeding port and the ink receiving port by restricting the posture of the ink cartridge when mounting the ink cartridge.

In this configuration, fitting between the cartridge-side engaging portion and the cartridge-mounting-chamber-side engaging portion which constitute an erroneous mounting preventing structure is started prior to contact between the ink feeding port on the ink cartridge side and the ink receiving port on the ink cartridge mounting chamber side by restricting the posture of the ink cartridge when mounting the ink cartridge. Therefore, if an attempt is made to mount an ink cartridge to an improper position different from that in which the ink cartridge is to be mounted, further insertion of the ink cartridge is prevented before the ink feeding port and the ink receiving port come into contact with each other, or a user may notify that the insertion is an erroneous insertion before the ink feeding port and the ink receiving port come into contact with each other. With the configuration described above, color mixture of ink is prevented.

Preferably, the restricting unit includes a projection provided on one of the ink cartridge and the ink cartridge mounting chamber, and a hole configured to receive the projection and provided on the other one of the ink cartridge and the ink cartridge mounting chamber, and a posture of the ink cartridge which allows contact between the ink feeding port and the ink receiving port is formed by entry of the projection into the hole.

In this configuration, since the restricting unit includes the projection and the hole, and the posture of the ink cartridge which allows contact between the ink feeding port and the ink receiving port is formed by entry of the projection into the hole, the restricting unit in a simple structure at a low cost is achieved.

Preferably, the plurality of the ink cartridges are arranged side by side along the lateral direction of the apparatus which corresponds to the direction interesting the depth direction of the apparatus, the projection is formed on a surface of the ink cartridge on the front side or the rear side thereof in the direction of the depth of the apparatus, and the inner dimension of the ink cartridge mounting chamber in the direction of the depth of the apparatus is larger than the dimension of the ink cartridge not including the projection, and is smaller than the dimension of the ink cartridge including the projection.

In this configuration, since the inner dimension of the ink cartridge mounting chamber in the direction of the depth of the apparatus is larger than the dimension of the ink cartridge not including the projection, and is smaller than the dimension of the ink cartridge including the projection, the ink cartridge cannot be inserted into the ink cartridge mounting chamber unless the projection is entered into the hole. Accordingly, contact of the improper ink feeding port with the ink receiving port is prevented further reliably.

Preferably, the projection or the hole is provided on a wall surface on the rear side in the ink cartridge mounting chamber in the direction of the depth of the apparatus.

In this configuration, since the projection or the hole is provided on the wall surface on the rear side in the ink cartridge mounting chamber in the direction of the depth of the apparatus, the user is allows to fit the projection and the hole only by an action to insert the ink cartridge rearward from the front side of the apparatus. In other words, fitting between the projection and the hole is achieved easily with a high workability.

Preferably, partitioning panels configured to define the mounting positions of the plurality of the ink cartridges are arranged on a bottom of the ink cartridge mounting chamber.

In this configuration, partitioning panels configured to define the mounting positions of the plurality of the ink cartridges are arranged on the bottom of the ink cartridge mounting chamber.

In this configuration, since the partitioning panels are arranged on the bottom of the ink cartridge mounting chamber, lateral rattling occurring when the ink cartridge is mounted may be prevented further reliably in comparison with a configuration in which the partitioning panels are provided on a peripheral wall surface (for example, on the wall surface on the rear side) in the ink cartridge mounting chamber.

### BRIEF DESCRIPTION OF THE DRAWINGS

The invention will be described with reference to the accompanying drawings wherein like numbers reference like elements.

FIG. 1 is an appearance perspective view of an ink jet printer of the invention (with a scanner unit in a closed state).

FIG. 2 is an appearance perspective view of the ink jet printer of the invention (with the scanner unit in an opened state).

FIG. 3 is a schematic cross-sectional side view of the ink jet printer of the invention.

FIG. 4 is a perspective view of a carriage (in a state in which an ink cartridge is not mounted).

FIG. 5 is a perspective view of the carriage (in the state in which the ink cartridge is not mounted).

FIG. 6 is a partly enlarged perspective view of FIG. 5.

FIG. 7 is a perspective view of the ink cartridge.

FIG. 8 is a lateral cross-sectional view of the carriage (in the state in which the ink cartridge is not mounted).

FIG. 9 is a lateral cross-sectional view of the carriage (in a course in which the ink cartridge is being mounted).

FIG. 10 is a lateral cross-sectional view of the carriage (in a state in which the ink cartridge is mounted).

FIG. 11 is a plan view of an ink cartridge of a second embodiment.

FIG. 12 is a plan view of the ink cartridge according to the second embodiment.

FIG. 13 is a perspective view of the ink cartridge according to the second embodiment.

FIG. 14 is a plan view of an ink cartridge according to a third embodiment.

FIG. 15 is a plan view of the ink cartridge according to the third embodiment.

FIG. 16 is a perspective view of the ink cartridge according to the third embodiment.

### DESCRIPTION OF EXEMPLARY EMBODIMENTS

An embodiment of the invention will be described with reference to drawings below. However, the invention is not limited to the embodiment described below, and various modifications are possible within the scope of the invention described in Claims. The embodiment of the invention will be described below on the condition that these modifications are also included in the scope of the invention.

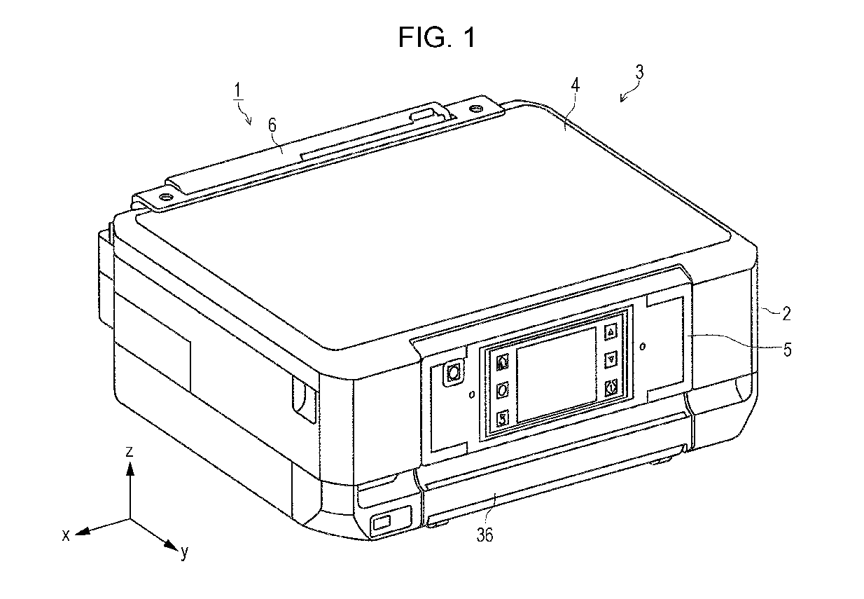

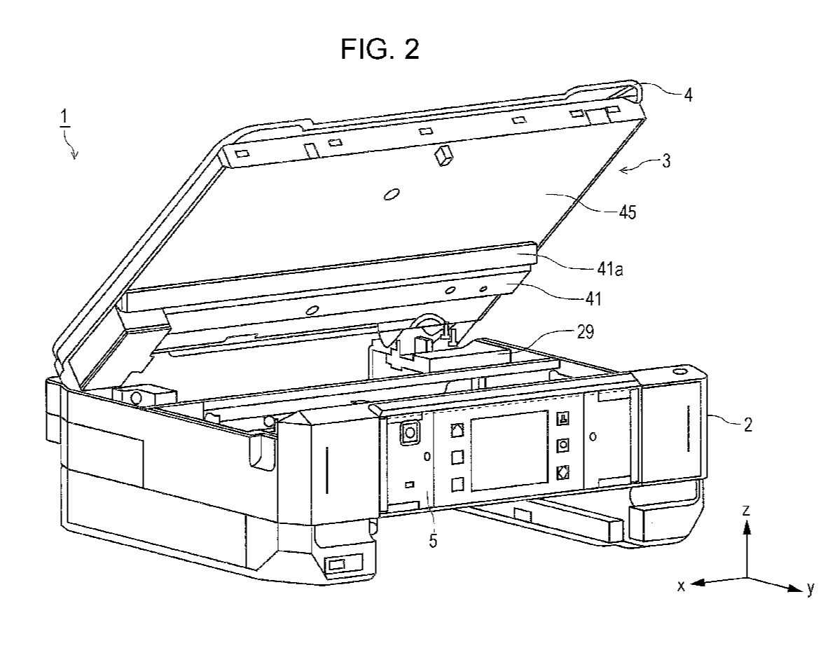

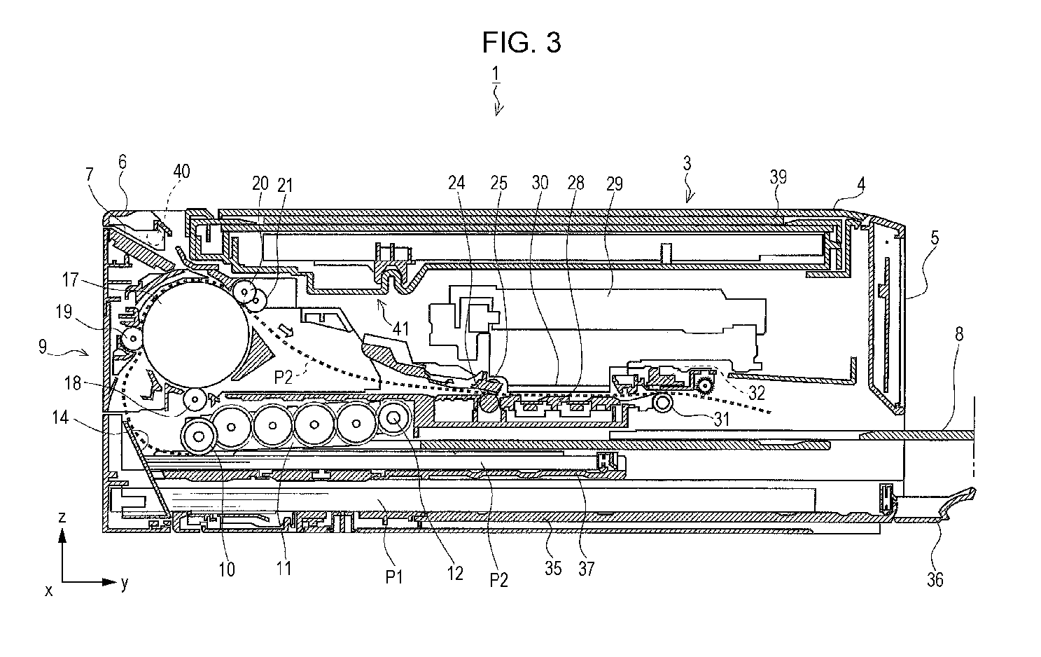

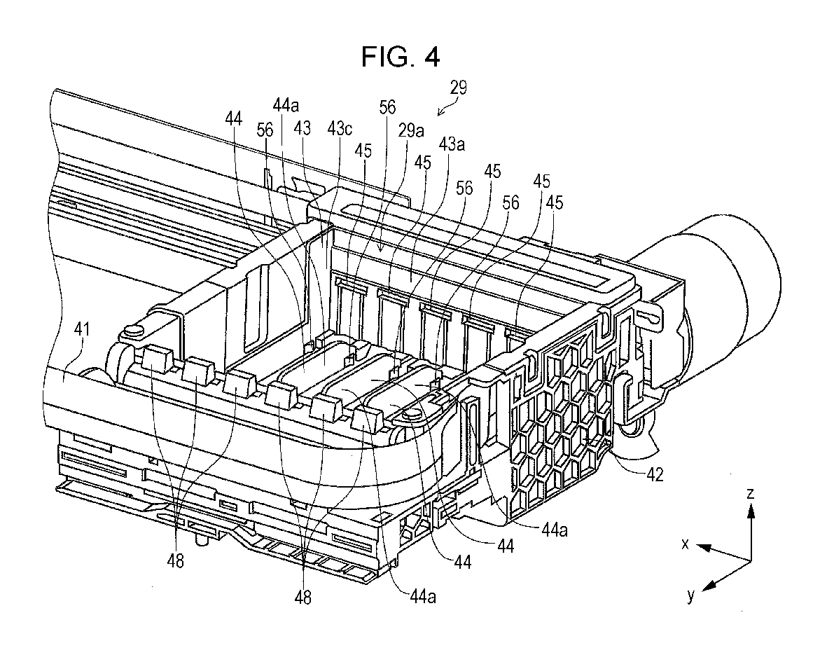

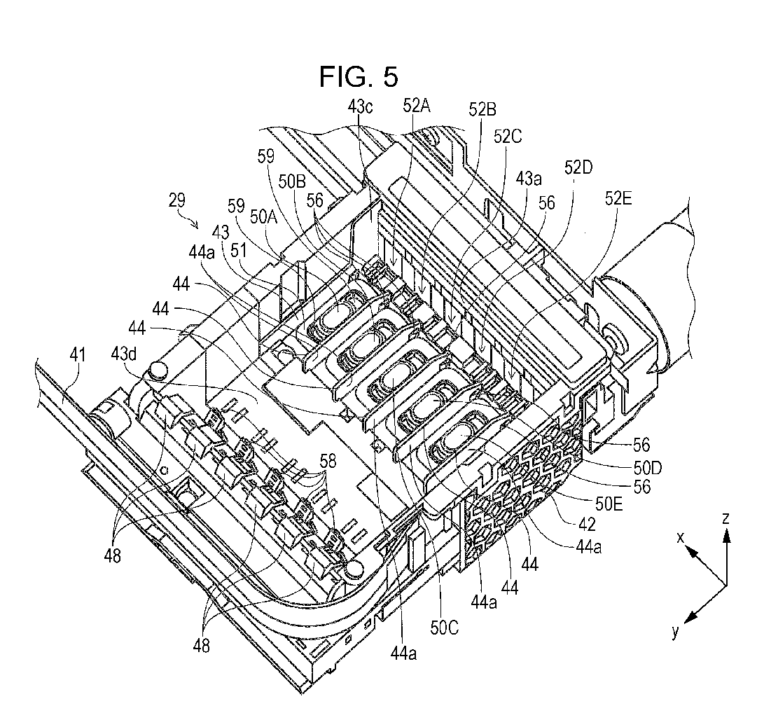

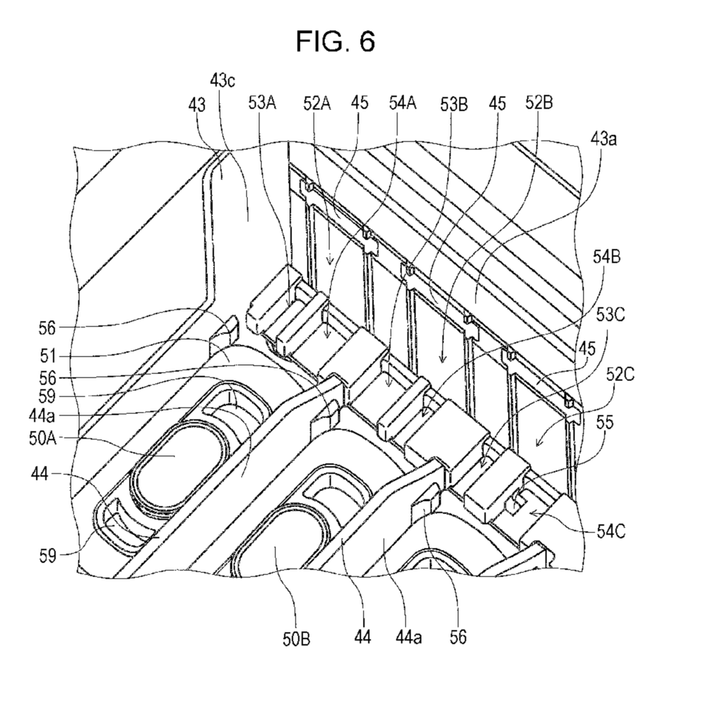

FIG. 1 and FIG. 2 are appearance perspective views of an ink jet printer (hereinafter, referred to as “printer”) 1 as an embodiment of a “recording apparatus” of the invention. FIG. 1 illustrates a state in which a scanner unit 3 is closed, and FIG. 2 illustrates a state in which the scanner unit 3 is opened. FIG. 3 is a cross-sectional side view illustrating a sheet transporting path of the printer 1. Furthermore, FIG. 4 and FIG. 5 are perspective views of a carriage 29 (in a state in which the ink cartridge is not mounted), and FIG. 6 is a partly enlarged perspective view of FIG. 5.

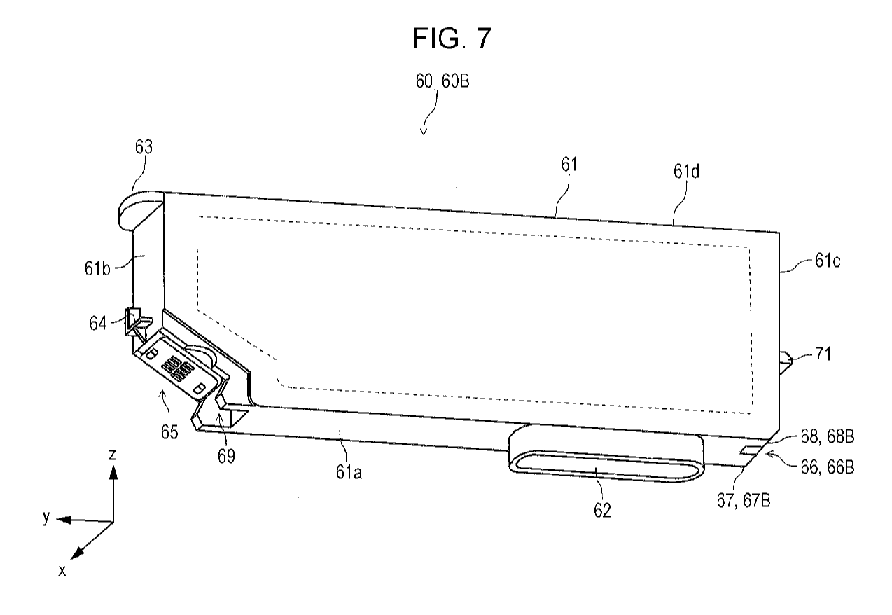

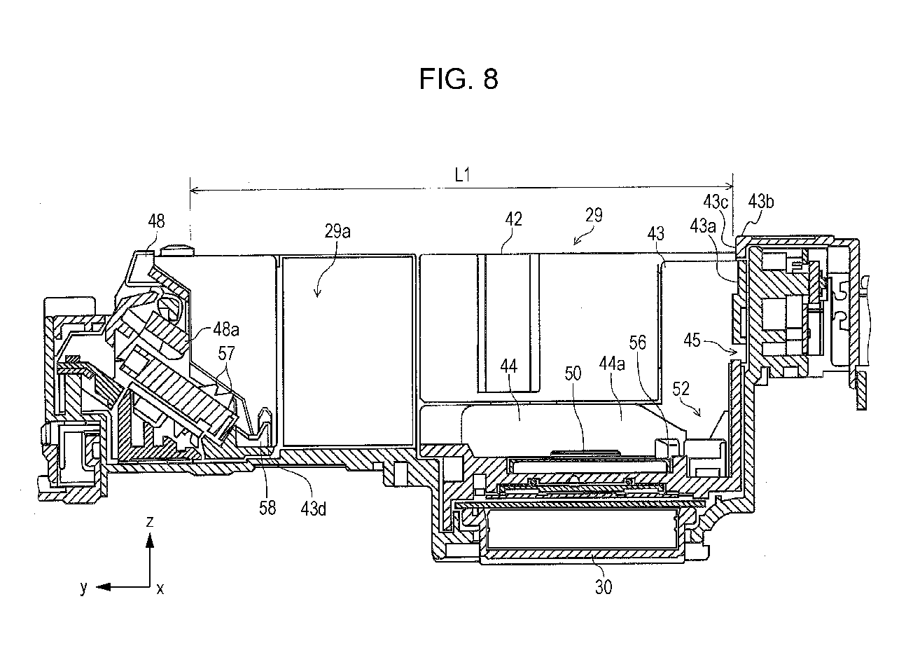

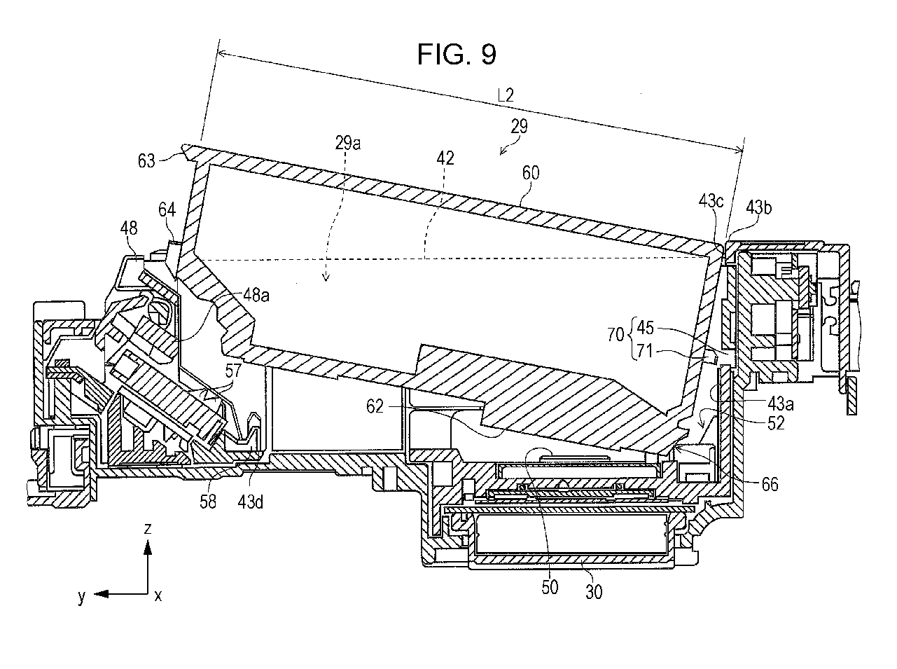

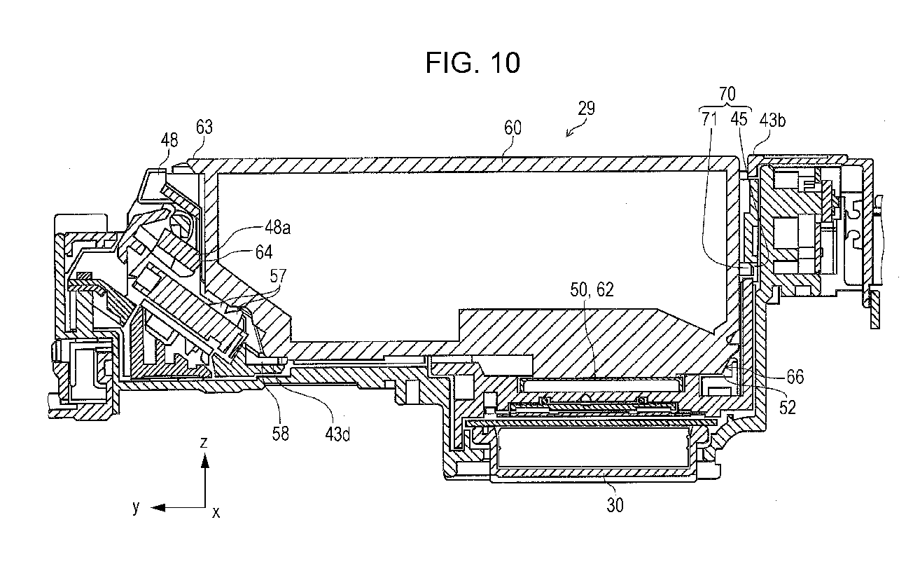

FIG. 7 is an appearance perspective view of an ink cartridge 60, FIG. 8 to FIG. 10 are lateral cross-sectional views of the carriage 29, FIG. 8 illustrates a state in which the ink cartridge 60 is not mounted, FIG. 9 illustrates a state in which the ink cartridge 60 is in the course in which the ink cartridge is being mounted, and FIG. 10 illustrates a state in which the ink cartridge 60 is mounted, respectively.

In x-y-z coordinate systems illustrated in FIG. 1 to FIG. 10, an x direction indicates the direction of the width of the apparatus (unit) and the direction of movement of the carriage 29, a y-direction indicates the depth direction of the apparatus (unit), and a z-direction indicates the height direction of the apparatus (unit), respectively. In the y-direction, which is the depth direction of the unit, the side where the operating panel 5 is provided corresponds to the front side of the apparatus (unit), and the direction opposite thereto corresponds to the rear side of the apparatus (unit). In the respective drawings, illustration of components of the printer 1 are omitted as needed.

In the following description, a general configuration of the printer 1 will now be described. The printer 1 includes the scanner unit 3 on the top of a recording unit 2 configured to perform ink jet recording on a recording sheet as an example of a medium so as to be rotatable. In other words, the printer 1 is configured as an ink jet multiple function processing machine having a scanning function in addition to an ink jet recording function.

The scanner unit 3 is rotatably coupled to the recording unit 2 via a rotating shaft 40 (FIG. 3), and is capable of taking a closed state (FIG. 1) and an opened state (FIG. 2) by the rotation. Then, a paper jam clearing work or a mounting-and-demounting work of the ink cartridge 60 or the like, described later, may be performed by opening the scanner unit 3.

A cover 4 on the top of the scanner unit 3 is an openable-and-closable cover, and an original document bed 39 (FIG. 3) of the scanner unit 3 appears when the cover 4 is opened.

Reference numeral 5 on the front surface of the apparatus denotes the operation panel provided with, for example, a power button, operation buttons for various print settings or execution of recording, a display unit configured to display items of print settings or previews of images to be printed. The operating panel 5 is configured to be tiltable so as to be capable of adjusting an angle for easy operation for a user. An angle of opening of the operating panel 5 is retained by an angle retaining unit, not illustrated, and the angle is retained even though an external force is applied in the closing direction for the operation of the button.

Reference numeral 36 on the front surface of the apparatus denotes an openable-and-closable cover provided on a lower tray 35. FIG. 1 illustrates a state in which the cover 36 is closed, and FIG. 3 illustrates a state in which the cover 36 is opened, respectively. Opening of the cover 36 exposes the lower tray 35, an upper tray 37, a paper discharge receiving tray 8 and enables execution of mounting-and-demounting operations of the lower tray 35 and the upper tray 37, or a sliding operation of the paper discharge receiving tray 8.

The paper discharge receiving tray 8 (FIG. 3) is provided so as to be displaceable between a stored position (FIG. 1) stored in the recording unit 2 and a projecting position (FIG. 3) projecting toward the front of the recording unit 2 by a sliding movement thereof caused by a motor, not illustrated. At the projecting position projecting toward the front of the recording unit 2, recording sheets discharged after the recording may be received thereby.

The lower tray 35 and the upper tray 37 provided above the lower tray 35 are capable of accommodating a plurality of recording sheets, and are configured to be mountable and demountable with respect to the recording unit 2, respectively. The cover 36 described above is provided on the lower tray 35 so as to be rotatable.

Subsequently, reference numeral 6 at a posterior upper portion of the recording unit 2 denotes an openable-and-closable manual insertion cover. Opening of the manual insertion cover 6 allows manual feeding of recording sheets using a manual insertion tray 7 (FIG. 3).

Subsequently, a sheet transporting path of the printer 1 will be described with reference mainly to FIG. 3. The printer 1 according to the embodiment includes the lower tray 35 and the upper tray 37 on a bottom of the apparatus, and the recording sheets are fed one by one from the lower tray 35 or the upper tray 37.

The upper tray 37 is provided so as to be displaceable between a feedable position (FIG. 2) and a retracted position (not illustrated) by a sliding movement and is configured to be displaced between the feedable position and the retracted position upon a reception of a motive power of the motor, not illustrated.

In FIG. 3, the sheets to be accommodated in the lower tray 35 are denoted by reference sign P1, and the sheets to be accommodated in the upper tray 37 are denoted by reference sign P2, respectively (hereinafter, when specific discrimination is not needed, it is referred simply as “sheet P”).

A paper feed roller 10 (also referred to as a pickup roller) driven to rotate by the motor, not illustrated, is provided on a swinging member 11 configured to swing about a rotating shaft 12. When the upper tray 37 is in a state of being slid to the frontmost position of the apparatus (the right side in FIG. 3; on the side of the direction of pulling out of the upper tray 37), that is, when the upper tray 37 is at the retracted position (not illustrated), the paper feed roller 10 rotates in contact with an uppermost sheet P1 accommodated in the lower tray 35 and feeds the uppermost sheet P1 from the lower tray 35.

When the upper tray 37 is at a dead end position of the sliding movement toward a rearmost position of the apparatus (the left side in FIG. 3: on the side of mounting direction of the upper tray 37 and, simultaneously, on the side of the feeding direction of the sheet), that is, at the feedable position of the upper tray 37 (the state in FIG. 3), the paper feed roller 10 rotates in contact with an uppermost sheet P2 accommodated in the upper tray 37 and feeds the uppermost sheet P2 from the upper tray 37. A broken line in FIG. 3 indicates a passing trajectory of the sheet P2 fed from the upper tray 37.

A separation ramp 14 is provided at a position facing distal ends of the lower tray 35 and the upper tray 37, and the sheet P fed from the lower tray 35 or the upper tray 37 advances to the downstream side while being in contact with the separation ramp 14 at a leading end thereof, so that separation of the uppermost sheet P to be fed and the sheets P from the next onward is achieved.

An inverting roller 17 to be driven to rotate by the motor, not illustrated, is provided ahead of the separation ramp 14, and the sheet P is bent and inverted by the inverting roller 17 and proceeds toward the front of the vehicle. Reference numerals 18, 19, 20, and 21 denote driven rollers which are capable of being rotated, and the sheets P fed at least from the respective trays are nipped by the driven roller 19 and the inverting roller 17, are nipped by the driven roller 20 and the inverting roller 17, and then are fed to the downstream side.

A transporting drive roller 24 driven by the motor, not illustrated, and a transporting drive roller 25 configured to rotate by being driven by the transporting drive roller 24 in contact therewith are provided ahead of the inverting roller 17, and feed the sheet P to a position under a recording head 30.

Subsequently, the recording head 30 constituting a recording portion which performs recording and being configured to discharge ink is provided on a bottom of the carriage 29. The carriage 29 is driven so as to reciprocate in a scanning direction of the recording head 30 (the x-direction: the depth direction of FIG. 3).

In the embodiment, the carriage 29 is configured to allow mounting of ink cartridges thereon, that is, a so-called on-carriage type. The interior of the carriage 29 is formed with an ink cartridge mounting chamber 29a in which the ink cartridges 60 (FIG. 7) are mounted (FIG. 4), and a plurality of (six in the embodiment) ink cartridges 60 are mounted in the ink cartridge mounting chamber 29a in a state of being arranged in the direction of movement of the carriage 29 (the x-direction). The ink cartridge 60 and the ink cartridge mounting chamber 29a will be described later in detail.

A supporting member 28 is provided at a position facing the recording head 30, and the distance between the sheet P and the recording head 30 is determined by the supporting member 28. A discharging unit including a discharge drive roller 31 driven to rotate by the motor, not illustrated, and a discharge driven roller 32 driven by the discharge drive roller 31 by being in contact therewith are provided on the downstream side of the supporting member 28. The sheet P on which the recording has performed by the recording head 30 is discharged toward the paper discharge receiving tray 8, described above, by these rollers.

The configuration of the paper transporting path of the printer 1 has been described thus far, and the ink cartridge 60 and the ink cartridge mounting chamber 29a will now described in detail.

In FIG. 4 and FIG. 5, a main body of the carriage 29 is formed by a carriage housing 42, and various configurations are assembled to the carriage housing 42, whereby the entire part of the carriage 29 is formed. The configurations described below is part of those configurations.

A flexible flat cable 41 for transmission of signals between a control unit on the main body side (not illustrated) and the recording head 30 or a linear encoder, not illustrated, extends from the carriage housing 42, and the flexible flat cable 41 is configured to be deformed to follow the movement of the carriage 29.

The carriage housing 42 is formed of a resin material into a box shape, and the inner side thereof corresponds to the ink cartridge mounting chamber 29a for mounting (accommodating) the ink cartridges 60. A cartridge mounting member 43 is disposed on the carriage housing 42, and the cartridge mounting member 43 is formed with a plurality of partitioning panels 44 at predetermined intervals along the direction of movement of the carriage 29 (the x-direction). The partitioning panels 44 have planes parallel to a y-z plane, and are formed so as to extend respectively in a y-direction and a z-direction.

The partitioning panels 44 are configured to form respective mounting areas for the plurality of ink cartridges 60, and in the embodiment, are disposed on a bottom of the ink cartridge mounting chamber 29a. The ink cartridge 60 of the embodiment has a shape elongated in the y-direction as illustrated in FIG. 7. Therefore, lateral rattling (in the x-direction) occurring when the ink cartridges 60 are mounted may be prevented more reliably than the configuration in which the partitioning panels 44 are provided on a rear wall surface (indicated by reference numeral 43a) of the cartridge mounting member 43 or on a front side wall surface. In the embodiment, five of the partitioning panels 44 are formed between left and right side walls of the ink cartridge mounting chamber 29a in order to mount six of the ink cartridges 60.

As illustrated in FIG. 4, FIG. 5, FIG. 6, and FIG. 8, projections 56 are provided on an inner wall 43c of the cartridge mounting member 43 and surfaces 44a of the partitioning panels 44. One each of the projections 56 is provided on left and right inner walls of the cartridge mounting member 43, that is, the inner wall 43c on the +x side and an inner wall on the −x side. One each of the projections 56 is provided on left and right surfaces of all the partitioning panels 44, that is, a surface on the +x side and the surface 44a on the −x side.

The projections 56 are provided on end portions of the partitioning panels 44 on the −y side. When the ink cartridge 60 is mounted in the ink cartridge mounting chamber 29a, part of an ink feeding portion 62 as an ink feeding port of the ink cartridge 60 illustrated in FIG. 7 and the projections 56 come into contact with each other, whereby the ink cartridge 60 is positioned in the x-direction.

In FIG. 4, FIG. 5, FIG. 6, and FIG. 8, only the inner wall 43c of the cartridge mounting member 43 on the +x side and the surfaces 44a of the partitioning panels 44 on the −x side, and the projections 56 formed on the inner wall 43c and the surfaces 44a are illustrated. In these drawings, the inner wall of the cartridge mounting member 43 on the −x side and the surfaces of the partitioning panels 44 on the +x side, and the projections formed on the inner wall and the surfaces are hidden. The projections formed on the inner wall of the cartridge mounting member 43 on the −x side and the surfaces of the partitioning panels 44 on the +x side are at the same positions in the y-direction as the projections 56 illustrated in FIG. 4, FIG. 5, FIG. 6, and FIG. 8, and are simply provided in mirror positions.

As illustrated in FIG. 5, FIG. 8, and FIG. 9, projections 58 are provided on a bottom wall 43d of the cartridge mounting member 43 on the front side (+y side). In contrast, as illustrated in FIG. 7, depressions 69 are provided at ends of bottom surfaces 61a of the ink cartridges 60 on the +y side. When the ink cartridge 60 is mounted in the ink cartridge mounting chamber 29a, the projecting portion 58 is received in the depression 69a, whereby the ink cartridge 60 is positioned in the y-direction.

A detailed configuration of the ink cartridge 60 will be described later.

Between the adjacent partitioning panels 44, or between the left and right side walls of the interior of the ink cartridge mounting chamber 29a and the partitioning panels 44, ink receiving portions 50 (in FIG. 5, indicated by reference signs 50A to 50E) for receiving a supply of ink from the ink cartridges 60 are provided. The ink receiving portions 50 are connected to the ink feeding portions 62 when the ink cartridges 60 are mounted. The ink receiving portions 50 are provided at six positions so as to correspond to the six ink cartridges. However, part of them are illustrated in FIG. 4 and FIG. 5.

In the embodiment, the ink receiving portions 50 each are provided with a porous filter (not illustrated) configured to drop ink fed from the ink cartridge 60. Examples of the porous filter which may be used include a stainless mesh and stainless non-woven cloth. In the ink cartridge 60, the ink feeding portion 62 connected to the ink receiving portion 50 is formed of, for example, a foam resin. In this regard, the ink feeding portion 62 is sealed by a sealing member (not illustrated) such as a cap or a film in the course of distribution of the ink cartridge 60, and the sealing member is removed by the user when mounting the ink cartridge 60.

Depressions 59 are provided in the respective ink receiving portions 50 (50A to 50E) as the ink receiving ports of the respective inks on the +y side and the −y side. The depressions 59 function as ink traps configured to receive ink spilt out from the ink receiving portions 50, a portion in the vicinity of the ink feeding portions 62 of the ink cartridges 60 or leaked ink.

Annular seal members 51 are arranged in the periphery of the respective ink receiving portions 50 (50A to 50E) so as to surround the ink receiving portions 50. The seal members 51 are members having resiliency such as synthetic rubber, and when the ink cartridges 60 are mounted, the seal members 51 come into tight contact with the ink feeding portions 62. Tight contact between the seal members 51 and the ink feeding portions 62 prevents the ink from easily leaking out from the ink feeding portion 62 to the outside, and enables efficient feeding of the ink to the ink receiving portions 50.

Subsequently, levers 48 are provided on the front side (the +y side) of the ink cartridge mounting chamber 29a. The levers 48 are resiliently deformable resin members capable of deforming substantially clockwise and counterclockwise in cross sections in FIG. 8 to FIG. 10, and are provided with locked portions 48a configured to be locked by locking portions 64 provided on side surfaces 61b of the ink cartridges 60 on the +y side when the ink cartridges 60 are mounted. As illustrated in FIG. 4 and FIG. 8 to FIG. 10, holes 45 are provided on a wall of the ink cartridge mounting chamber 29a on the rear side (the −y side) of the ink cartridge mounting chamber 29a, that is, on the rear wall surface 43a. Projections 71 provided on side surfaces 61c of the ink cartridges 60 on the −y side are locked in these holes 45 when the ink cartridges 60 are mounted.

In other words, the mounted state of each of the ink cartridges 60 is maintained by the locking portion 64 locking on the locked portion 48a and the projection 71 locking in the hole 45. More specifically, when the ink cartridge 60 is mounted in the ink cartridge mounting chamber 29a, an upper surface of the locking portion 64 (a surface on the +z side) is locked by the locked portion 48a. The upper surface of the projection 71 (a surface on the +z side) is locked by the hole 45. Accordingly, the movement of the ink cartridge 60 to the upper side (+z side) is restricted, and hence the mounted state of the ink cartridge 60 is maintained.

When removing the ink cartridge 60, the user operates the lever 48 toward the front of the apparatus, so that the locked state of the locking portion 64 with respect to the locked portion 48a is released. Subsequently, the user holds a lug portion 63 provided on the side surface 61b of the ink cartridge on the +y side at an end thereof on the side of an upper surface 61d and pulls the same upward, whereby the ink cartridge 60 may be removed.

The ink cartridge 60 has a flat box shape elongated in the y-direction as illustrated in FIG. 7, and includes the ink feeding portion 62 described above on a bottom surface rather on the posterior side of the apparatus (the right side in FIG. 7). A circuit substrate 65 provided with a storage medium that stores various data such as ink color, and the remaining amount of ink is arranged on the bottom on the front side of the apparatus (the left side in FIG. 7). When the ink cartridge 60 is mounted in the ink cartridge mounting chamber 29a, the circuit substrate 65 comes into electrical contact with a carriage side terminal portion 57 provided on the bottom of the ink cartridge mounting chamber 29a, which enables data transmission between the body-side control unit and the above-described storage medium or data update in the above-described storage medium.

The ink cartridge 60 is formed with the lug portion 63 on an upper portion on the front side of the apparatus, so that the user is capable of demounting the ink cartridge 60 easily by holding the lug portion 63 when demounting the ink cartridge 60.

Subsequently, the ink cartridge 60 according to the embodiment includes the projection 71 on a wall surface on the posterior side of the apparatus, and includes also a cartridge-side engaging portion 66 below the projection 71. The projection 71 and the cartridge-side engaging portion 66 are closely associated with each other, and the cartridge-side engaging portion 66 will be described firstly below.

The cartridge-side engaging portion 66 is a portion having a form inherent among a plurality of ink cartridges 60. The ink cartridge 60 illustrated as an example in FIG. 7 is an ink cartridge to be connected to the ink receiving portion 50B illustrated in FIG. 5. Hereinafter, this cartridge is described as an ink cartridge 60B. A cartridge-side engaging portion having a form inherent to the ink cartridge 60B provided on the ink cartridge 60B is referred to as a cartridge-side engaging portion 66B.

The cartridge-side engaging portion 66B provided on the ink cartridge 60B includes a first projection 67 (67B) and a second projection 68 (68B). The first projection 67 (67B) and the second projection 68 (68B) are configured by using a lower corner portion of the ink cartridge 60B. The cartridge-side engaging portion 66B having the first projection 67B and the wall surface 68B fits in a cartridge mounting chamber engaging portion 52B provided on the bottom of the ink cartridge mounting chamber 29a when the ink cartridge 60B is mounted.

More specifically, the cartridge-mounting-chamber-side engaging portion 52B includes a first depression 53B and a second depression 54B as illustrated in FIG. 6. The first depression 53B is formed to be slightly larger than the thickness of the first projection 67B in the x-direction so as to allow the first projection 67B of the ink cartridge 60B to just fit therein. The second depression 54B is also formed to be slightly larger than the thickness of the second projection 68B in the x-direction so as to allow the second projection 68B of the ink cartridge 60B to just fit therein.

With the configuration as described above, the cartridge-side engaging portion 66B provided on the ink cartridge 60B fits only in the cartridge-mounting-chamber-side engaging portion 52B as an adequate counterpart in which the cartridge-side engaging portion 66B is to be fitted, and cannot fit in other cartridge-mounting-chamber-side engaging portions (for example, engaging portions indicated by reference numerals 52A, 52C, 52D, and 52E in FIG. 5 and FIG. 6).

In other words, the cartridge-side engaging portion 66B and the cartridge-mounting-chamber-side engaging portion 52B are in a relationship of one-to-one correspondence such as the relationship between a key and a keyhole. Then, those of other cartridge-side engaging portions 52A, 52C, 52D, and 52E illustrated in FIG. 5 also fit only in the cartridge-side engaging portions provided on the corresponding ink cartridges. Such a relationship of correspondence is achieved by differentiating the thicknesses (thickness in x-direction) of the first projection 67 and the second projection 68 constituting the cartridge-side engaging portion 66 and a first depression 53 and a second depression 54 constituting a cartridge-mounting-chamber-side engaging portion 52 from one ink cartridge to another.

With the erroneous mounting preventing structure as described above, mounting of an ink cartridge on a position different from a proper position where the ink cartridge in question is to be mounted by the user is prevented. In the embodiment, the fitting forms inherent among the respective ink cartridges are configured by the thicknesses of the first projection 67, the second projection 68, the first depression 53, and the second depression 54. However, the invention is not limited thereto, and the fitting forms inherent among the ink cartridges are realized by adjusting various items such as the positions, the shape, the dimension in the z-direction, the dimension in the y-direction, and the like of the projections or the depressions or by combining such various items.

For example, in the cartridge-mounting-chamber-side engaging portion indicated by the reference numeral 52C in FIG. 6, a third depression 55 is provided in addition to the first depression 53C and the second depression 54C. In the third depression 55, a projection (not illustrated) formed on the ink cartridge side fits. Accordingly, the cartridge-mounting-chamber-side engaging portion 52C allows only the adequate cartridge-side engaging portion corresponding thereto to fit therein.

With the erroneous mounting preventing structure as described above, even though an attempt is made to mount an ink cartridge in a place different from a place where the ink cartridge is to be mounted, the ink cartridge is prevented from being completely mounted. However, if the ink feeding portion 62 of the ink cartridge 60 and the ink receiving portions 50 of the ink cartridge mounting chamber 29a come into contact with each other prior to such an erroneous mounting preventing function works, color mixture may result.

In order to solve the problem described above, the projection 71 provided on the ink cartridge 60 and the hole 45 provided on the ink cartridge mounting chamber 29a constitute a restricting unit 70 configured to start fitting between the cartridge-side engaging portion 66 and the cartridge-mounting-chamber-side engaging portion 52 prior to contact between the ink feeding portion 62 and the ink receiving portions 50 by restricting the posture of the ink cartridge 60 at the time of mounting the ink cartridge.

More specifically, a plurality of holes 45 are formed on the rear wall surface 43a on the posterior side of the apparatus in the ink cartridge mounting chamber 29a so as to correspond to the respective ink cartridges. When mounting the ink cartridge 60 from the state in which the ink cartridge is not mounted, the user inserts the ink cartridge 60 into the ink cartridge mounting chamber 29a from the front side of the apparatus toward the inside. At this time, as illustrated in FIG. 9, as the ink cartridge 60 is pivoted from a slanted posture in which a side on the front side of the apparatus is lifted upward with the inner wall 43c of the ink cartridge mounting chamber 29a as a pivot point of rotation, the projection 71 firstly enters the hole 45, and then fitting between the cartridge-side engaging portion 66 and the cartridge-mounting-chamber-side engaging portion 52 starts.

Here, contact between the ink feeding portion 62 and the ink receiving portions 50 is not achieved unless the fitting between the cartridge-side engaging portion 66 and the cartridge-mounting-chamber-side engaging portion 52 is completely done. Therefore, the ink feeding portion 62 of the ink cartridge 60 and the ink receiving portions 50 of the ink cartridge mounting chamber 29a are prevented from coming into contact with each other prior to the realization of the erroneous mounting preventing function.

It is because the restricting unit 70 including the projection 71 and the hole 45 restricts the posture of the ink cartridge 60. In other words, as illustrated in FIG. 9, even through an attempt is made to insert the ink cartridge 60 into the ink cartridge mounting chamber 29a, for example, in a horizontal posture instead of the slanted posture in which the side on the front side of the apparatus is lifted upward, since the projection 71 is provided, the projection 71 is caught by an upper edge 43b of the rear wall 43a and hence the ink cartridge 60 cannot be inserted. In the same manner, even though an attempt is made to insert the ink cartridge 60 into the ink cartridge mounting chamber 29a in a slanted posture in which a side on the posterior side of the apparatus of the ink cartridge 60 is lifted upward, the projection 71 is caught by the upper edge 43b of the rear wall 43a, so that the ink cartridge 60 cannot be inserted.

Reference sign L1 in FIG. 8 is a dimension of the ink cartridge mounting chamber 29a in the direction of the depth of the apparatus, and reference sign L2 in FIG. 9 is a dimension in the depth direction of the depth of the apparatus of the ink cartridge 60 except for the projection 71. The relationship is the dimension L1>L2. When the dimension of the ink cartridge 60 including the projection 71 is assumed to be [L2+α], the dimension L1<[L2+α] is satisfied.

Therefore, when inserting the ink cartridge 60 into the ink cartridge mounting chamber 29a, it is necessary to hold the ink cartridge 60 in the slanted posture in which the side on the front side of the apparatus is lifted upward as illustrated in FIG. 9 and causes the projection 71 to enter the ink cartridge mounting chamber 29a first. Accordingly, the cartridge-side engaging portion 66 positioned at a corner of a lower portion on the front side in the direction of insertion engages the cartridge-mounting-chamber-side engaging portion 52 on a priority basis.

If the ink cartridge is an improper ink cartridge which is not to be mounted at that time, the cartridge-side engaging portion 66 cannot be fitted in the cartridge-mounting-chamber-side engaging portion 52, and hence the ink feeding portion 62 does not come into contact with the ink receiving portions 50. The positional relationship between the ink feeding portion 62 and the ink receiving portion 50 is as described thus far. In this configuration, a problem of color mixture caused by the ink feeding portion 62 of the ink cartridge 60 and the ink receiving portion 50 of the ink cartridge mounting chamber 29a coming into contact with each other prior to the realization of the erroneous mounting preventing function may be prevented.

In the embodiment, the above-described projection 71 is formed on a wall surface of the ink cartridge in the direction of insertion (on the posterior side of the apparatus), and the hole 45 is provided on the wall surface 43a on the rear side of the ink cartridge mounting chamber 29a. Therefore, the user is allows to fit the projection 71 and the hole 45 only by an action to insert the ink cartridge 60 rearward from the front side of the apparatus. In other words, fitting between the projection 71 and the hole 45 is achieved easily with a high workability.

Subsequently, second and third embodiments of the ink cartridge which is mountable on the printer 1 described above will be described. In the following description, the same configurations as those of the ink cartridge 60 described with reference to FIG. 7 before are denoted by the same reference numerals and detailed description thereof is partly omitted. From among various different points from the ink cartridge 60, description of those having no bearing on the invention will be omitted.

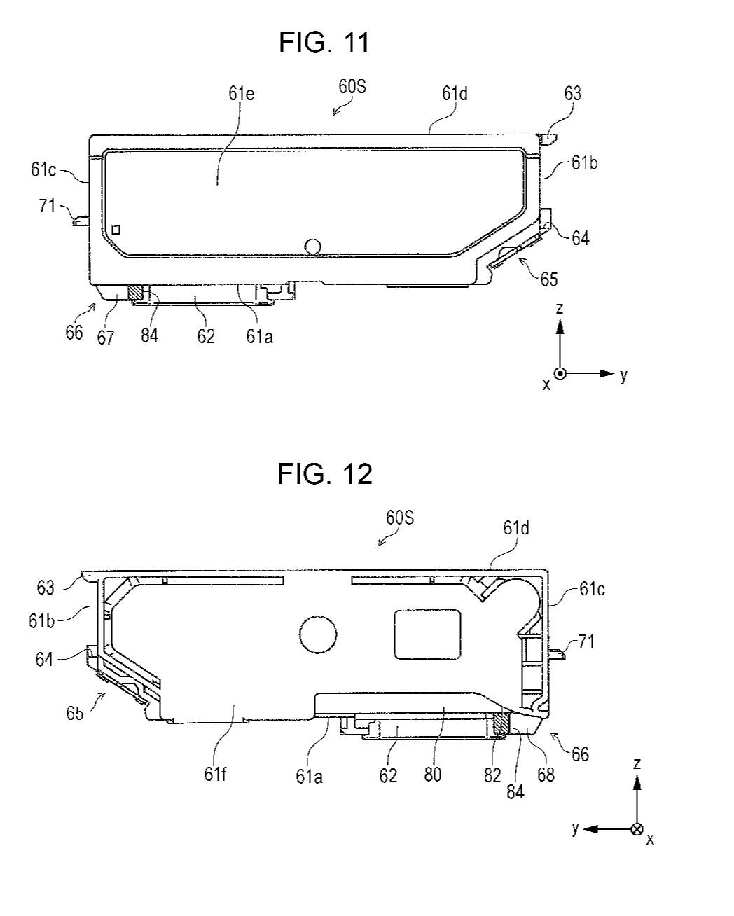

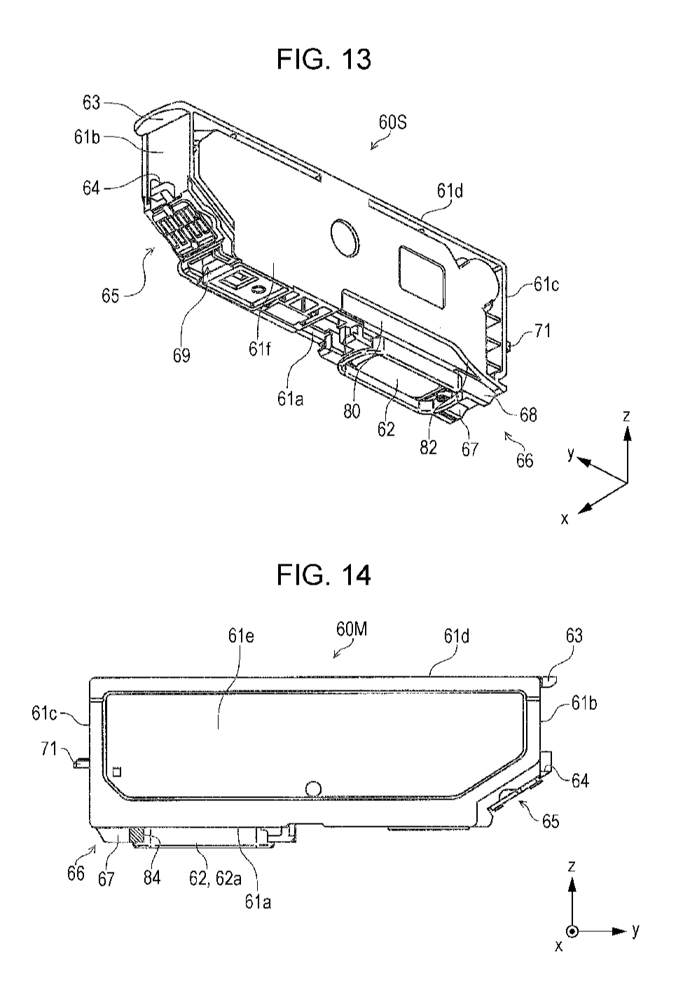

FIG. 11 to FIG. 13 are drawings illustrating an ink cartridge 60S according to the second embodiment. FIG. 11 is a plan view of the ink cartridge 60S viewed from a +x direction toward a −x direction. In other words, it is a drawing illustrating a side surface (right side surface) 61e on the +x side of the ink cartridge 60S. FIG. 12 is a plan view of the ink cartridge 60S viewed from the −x direction toward the +x direction. In other words, it is a drawing illustrating a side surface (left side surface) 61f on the −x side of the ink cartridge 60S. FIG. 13 is a perspective view of the ink cartridge 60S.

A first different point from the ink cartridge 60 according to a first embodiment illustrated in FIG. 7 is that an indentation 80 which receives at least part of the partitioning panel 44 (see FIG. 5, FIG. 6, and FIG. 8) is provided on the right side surface. An inner edge 82 of the indentation 80 on the −y side functions as a guide which guides an ink cartridge 61A to the mounted posture smoothly by coming into abutment with an upper edge of the partitioning panel 44 when the ink cartridge 60S is mounted in the ink cartridge mounting chamber 29a.

In a state in which the ink cartridge 60S is mounted in the ink cartridge mounting chamber 29a, an upper portion of the partitioning panel 44 is accommodated in the indentation 80. With the provision of the indentation 80, the ink cartridges 60S may be arranged in the ink cartridge mounting chamber 29a without forming gaps therebetween. Accordingly, the maximum amount of storage of ink in the ink cartridge 60S may be secured and increase in size of the carriage 29 and hence of the printer 1 may be prevented.

A second different point from the ink cartridge 60 according to the first embodiment illustrated in FIG. 7 is that an abutting surface 84 (hatched portions in FIG. 11 and FIG. 12) is provided on the −y side of the ink feeding portion 62. In the state in which the ink cartridge 60S is mounted in the ink cartridge mounting chamber 29a, the abutting surface 84 comes into abutment with the projections 56 provided on the inner wall 43c of the cartridge mounting member 43 and the surface 44a of the partitioning panel 44, so that the movement of the ink cartridge 60S, specifically, the movement of the ink feeding portion 62 in the x-direction may be suppressed more reliably.

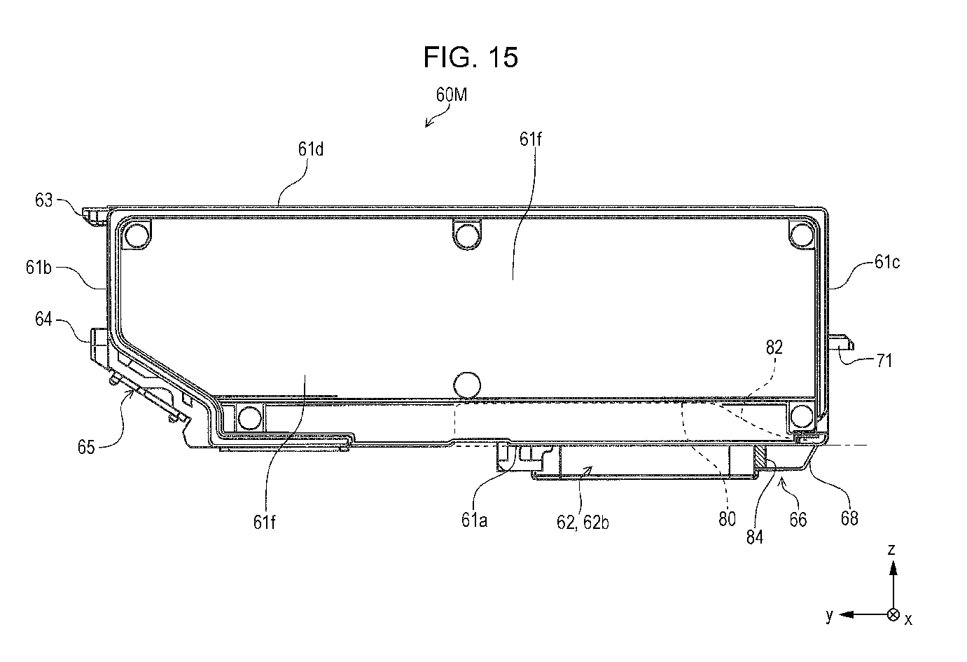

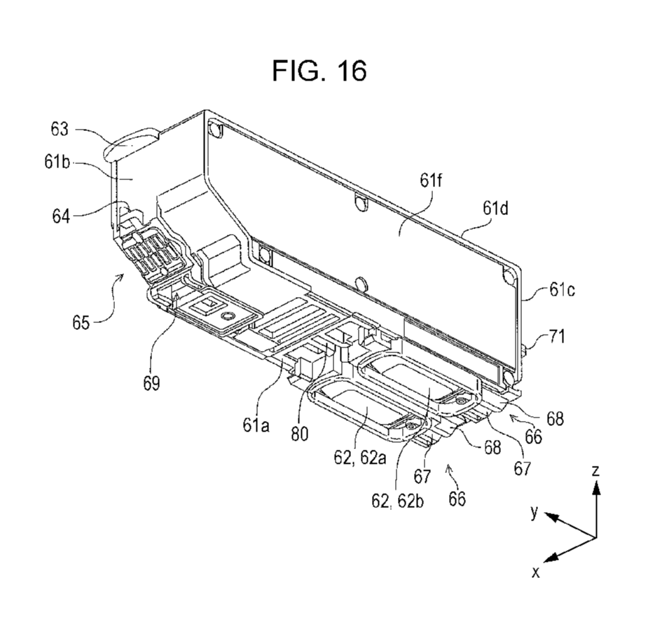

FIG. 14 to FIG. 16 are drawings illustrating an ink cartridge 60M according to the third embodiment. FIG. 14 is a plan view of the ink cartridge 60M viewed from the +x direction toward the −x direction. In other words, it is a drawing illustrating the side surface (right side surface) 61e on the side of the +x direction of the ink cartridge 60M. FIG. 15 is a plan view of the ink cartridge 60M viewed from the −x direction toward the +x direction. In other words, it is a drawing illustrating the side surface (left side surface) 61f on the −x side of the ink cartridge 60M. FIG. 16 is a perspective view of the ink cartridge 60M.

Different points among the ink cartridge 60M according to the third embodiment, the ink cartridge 60 according to the first embodiment illustrated in FIG. 7, and the ink cartridge 60S according to the second embodiment illustrated in FIG. 11 to FIG. 13 are as follows.

The ink cartridge 60M has a width which corresponds to approximately the sum of the widths of the ink cartridges 60 and 60S according to the first and second embodiments, and is mounted across two left and right cartridge slots with one of the partitioning panels 44 at the center thereof. The ink cartridge 60M is provided with two of the ink feeding portions 62. One of the two ink feeding portions 62 provided on the +x side is referred to as an ink feeding portion 62a and the one provided on the −x side is referred to as an ink feeding portion 62b.

The ink cartridge 60M is provided with the indentation 80 configured to receive at least part of the partitioning panel 44 in the same manner as the ink cartridge 60S according to the second embodiment. The indentation 80 is provided between the two ink feeding portions 62a and 62b. The function of the indentation 80 is the same as that of the indentation 80 of the ink cartridge 60S according to the second embodiment.

The ink cartridge 60M is provided with the abutting surface 84 (the hatches portions in FIG. 14 and FIG. 15) on the −y side of the ink feeding portion 62 in the same manner as the ink cartridge 60S according to the second embodiment.

FIG. 14 illustrates only the abutting surface 84 on the side of the +x side of the ink feeding portion 62a. However, the abutting surface 84 exists on the −x side of the ink feeding portion 62a. Also, FIG. 15 illustrates only the abutting surface 84 on the −x side of the ink feeding portion 62b. However, the abutting surface 84 also exists on the +x side of the ink feeding portion 62b. It is also possible to omit one or two of these four abutting surfaces.

The ink cartridge 60M is also provided with the indentation 80 which receives at least part of the partitioning panel 44 (see FIG. 5, FIG. 6, and FIG. 8) in the same manner as the ink cartridge 60S according to the second embodiment. Therefore, in the same manner as the ink cartridge 60S, the ink cartridges 60M may be arranged in the ink cartridge mounting chamber 29a without forming gaps therebetween. Accordingly, the maximum amount of storage of ink in the ink cartridge 61B may be secured and increase in size of the carriage 29 and hence of the printer 1 may be prevented.

The ink cartridge 60M is also provided with the abutting surface 84 on the −y side of the ink feeding portion 62 (62a and 62b) in the same manner as the ink cartridge 60S according to the second embodiment. Therefore, in a state in which the ink cartridge 60M is mounted in the ink cartridge mounting chamber 29a, the abutting portion 84 comes into abutment with the projections 56 provided on the inner wall 43c of the cartridge mounting member 43 and the surface 44a of the partitioning panel 44, so that the movement of the ink cartridge 60M, specifically, the movement of the ink feeding portion 62 (62a and 62b) in the x-direction may be suppressed more reliably.

The respective embodiments described thus far are examples only, and it is needless to say that the invention is not limited to these embodiments. In particular, the above-described restricting unit 70 is provided with the projection 71 on the ink-cartridge side and the hole 45 on the ink-mounting-chamber side. However, vice versa is also applicable. Alternatively, other configurations may be employed. In the embodiment, the restricting unit 70 is composed of the projection 71 and the hole 45, and the posture of the ink cartridge 60 in which the ink feeding portion 62 and the ink receiving portion 50 may come into contact with each other is achieved by fitting the projection 71 into the hole 45, so that the restricting unit 70 in a simple structure at a low cost is achieved.

The printer 1 according to the embodiments described above has a configuration of a so-called multiple function processing machine provided with the scanner unit 3 on the top thereof. However, a so-called single function processing machine which is not provided with the scanner unit 3 is also applicable. In the embodiment, the apparatus is of a so-called on-carriage type in which the ink cartridge 60 is mounted on the carriage 29. However, a so-called off-carriage type in which the ink cartridge is mounted in a cartridge mounting chamber provided fixedly without mounting the ink cartridge 60 on the carriage 29 is also applicable.

In addition, in the respective embodiments described above, the invention is applied to an ink jet printer as an example of the recording apparatus. However, the invention may be applied generally to other liquid ejection apparatuses.

Here, the liquid ejection apparatus includes not only the recording apparatuses such as printers, copying machines or facsimiles which uses an ink jet recording head and records on a recorded medium by ejecting ink from the recording head, but also apparatuses configured to eject liquid corresponding the application thereof instead of ink from a liquid ejection head corresponding to the ink jet recording head to an ejected medium corresponding to the recorded medium to cause the liquid to be adhered to the recorded medium.

Examples of the liquid ejection head include a color material ejection head used for manufacturing color filters such as liquid crystal displays or the like, an electrode material (conductive paste) ejection head used for forming electrodes of organic EL displays or surface emission-type displays (FED) or the like, a biological organic substance ejection head used for manufacturing biochips, and a sample ejection head as a precision pipette in addition to the above-described recording head.

The entire disclosure of Japanese Patent Application No. 2012-152147, filed Jul. 6, 2012 and 2012-175199, filed Aug. 7, 2012 are expressly incorporated by reference herein.

What is claimed is:

1. A recording apparatus comprising:
a recording head configured to perform recording; and
an ink cartridge mounting chamber in which a plurality of ink cartridges each having an ink feeding port configured to feed ink discharged from the recording head are mounted, wherein
the ink cartridge mounting chamber includes:
a side surface provided with a pivot point to allow the ink cartridges to be mounted by being pivoted,
ink receiving ports connected to the ink feeding ports and provided so as to correspond to the plurality of the ink cartridges,
cartridge-mounting-chamber-side engaging portions configured to be fitted in cartridge-side engaging portions provided on the ink cartridges and each having a form inherent among the plurality of the ink cartridges; and
a restricting unit configured to start fitting between the cartridge-side engaging portion and the cartridge-mounting-chamber-side engaging portion prior to contact between the ink feeding port and the ink receiving port by restricting the posture of the ink cartridge when mounting the ink cartridge.

2. The recording apparatus according to claim 1, wherein
the restricting unit includes a projection provided on one of the ink cartridge and the ink cartridge mounting chamber, and a hole configured to receive the projection and provided on the other one of the ink cartridge and the ink cartridge mounting chamber, and
a posture of the ink cartridge which allows contact between the ink feeding port and the ink receiving port is formed by entry of the projection into the hole.

3. The recording apparatus according to claim 2, wherein the plurality of the ink cartridges are arranged side by side along the lateral direction of the apparatus which corresponds to the direction interesting the depth direction of the apparatus,
the projection is formed on a surface of the ink cartridge on the front side or the rear side thereof in the direction of the depth of the apparatus, and
the inner dimension of the ink cartridge mounting chamber in the direction of the depth of the apparatus is larger than the dimension of the ink cartridge not including the projection, and is smaller than the dimension of the ink cartridge including the projection.

4. The recording apparatus according to claim 3, wherein the projection or the hole is provided on a wall surface on the rear side in the ink cartridge mounting chamber in the direction of the depth of the apparatus.

5. The recording apparatus according to claim 1, wherein partitioning panels configured to define the mounting positions of the plurality of the ink cartridges are arranged on the bottom of the ink cartridge mounting chamber.
